(19) United States
(12) Patent Application Publication
(10) Pub. No.: US 2017/0327368 A1
(43) Pub. Date: Nov. 16, 2017

(54) DISPENSING HEAD COOLING SYSTEM

(71) Applicant: Mohit Arora, JALANDHAR (IN)

(72) Inventor: Mohit Arora, JALANDHAR (IN)

(21) Appl. No.: 15/162,655

(22) Filed: May 24, 2016

Related U.S. Application Data
(60) Provisional application No. 62/335,158, filed on May 12, 2016.

(51) Int. Cl. B67D 1/08; B67D 1/14

(52) U.S. Cl. CPC B67D 1/0857; B67D 1/1477

(57) ABSTRACT

An apparatus for cooling a liquid being dispensed through a dispensing tower includes a replaceable cooling shank that sealingly engages a delivery nipple with one or more internally mounted annular seals. The replaceable cooling shank facilitates quick and cost efficient maintenance of the dispensing tower when the annular seals become worn.

### BACKGROUND OF THE INVENTION

The present invention relates generally to beverage dispensing systems of the type having a dispensing faucet, a beverage container remote from the faucet and a feed line interconnecting the faucet with the beverage container to permit beverage to flow from the container to the faucet. In greater particularity the present invention provides a cooling head that cools the beverage to the proper temperature at dispensing and which is readily serviced and maintained after prolonged use.

Dispensing heads for beverages such as beer and soft drinks have long been used to dispense such beverages at an appropriate chilled temperature, however, the technology to accomplish this feat when the storage container for the beverage was remotely located or not chilled has varied and evolved. Refrigerated lines from the container to the dispensing head have been employed at some expense and with some success. One prior art solution, proposed in U.S. Pat. No. 6,446,458 B1, for eliminating refrigerated lines provided a cooling component disposed in contact with both the product line carrying the beverage and with the shank to which the dispensing faucet is connected so that the beverage is continuously cooled at the time it exits the dispensing faucet. Although satisfactory for its intended result the proposed design was problematic from use and maintenance standpoint in as much as the connection required the use of O-ring seals which must be replaced after about three years of usage. The specific design taught by the prior art made it extraordinarily difficult to service the dispensing heads in the field and with thousands of such units in service, significant time and expense is used in having skilled service technicians working on the dispensers. Specifically, the prior design used a connector tube fixedly interconnected with a connector probe such as welding. The connector portion or collar of the connector probe is then press fit into a bore of a cooling component wherein the body portion of the connector probe extends into internally threaded bore 4 to form an annular shaped opening. The O-rings which were carried by the connector probe are thus permanently affixed within the bore of the cooling component. Consequently, the product is not entirely satisfactory in actual use because it is difficult to maintain and service.

### SUMMARY OF THE PRESENT INVENTION

It is an object of the present invention to provide at the tap cooling of a beverage with a cooling design that may be readily serviced.

It is a further object of the invention to reduce the down time of a beverage tap due to service and maintenance by making the tap easy to service.

It is a further object of the invention to reduce the cost of maintenance of beverage taps by improving the configuration of the tap for easier and less expensive maintenance.

The forgoing objects of the invention are accomplished in the below described embodiments by providing a structure which facilitates easy removal and maintenance of the sealing elements in the dispensing heads.

These and other objects and advantages of the invention will become apparent from the following detailed description of the preferred embodiment of the invention.

### BRIEF DESCRIPTION OF THE DRAWINGS

An apparatus for dispensing a beverage is depicted in the accompanying drawings which form a portion of this disclosure and wherein:

FIG. 1 is an exploded view of the tower components;

FIG. 2 is a sectional view of the cold block supply pipe assembly;

FIG. 3 is a Sectional view of the Glycol Shank;

FIG. 4 is a sectional view of the welding nipple;

FIG. 5 is an exploded view of the edge tap long spout;

### DESCRIPTION OF THE PREFERRED EMBODIMENT

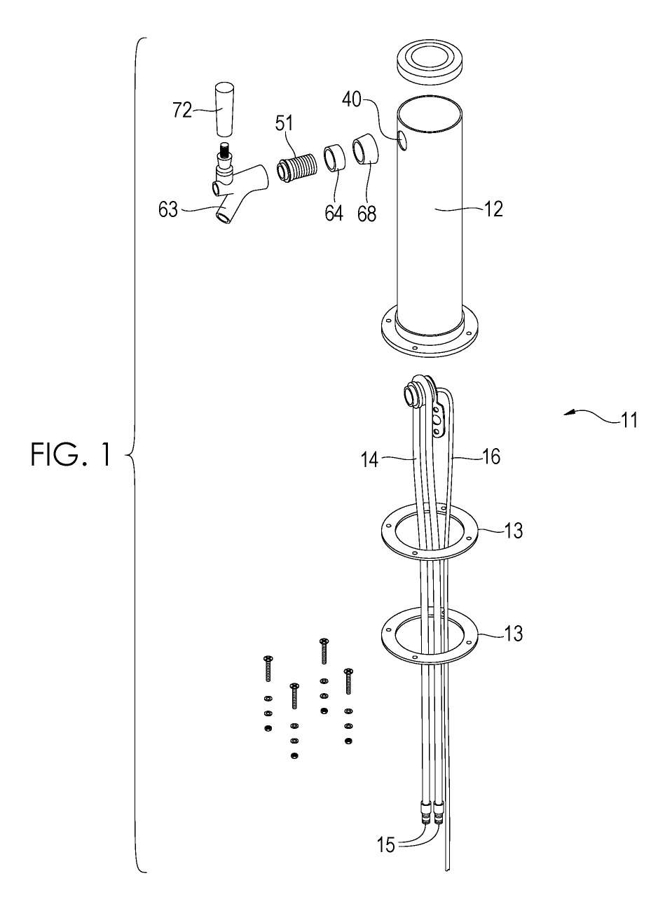

Referring to the FIGS. 1-6 for a clearer understanding of the invention, it may be seen that the preferred embodiment of the invention contemplates use in a beverage dispensing tower in a commercial establishment, although the same structure may be used in a private bar as well. It is to be understood that in such systems the beverage is stored in a remote location and is delivered to the bar area via a suitable conduit as is well known in the art.

Referring to FIG. 1, it may be seen that the dispensing tower 11 utilizes a cylindrical tower pipe assembly 12 to provide a housing within which the cooling medium and beverage are delivered. The tower pipe assembly 12 is conventionally mounted to the bar or counter top (not shown) using tower base washers 13 and a screw set. Extending within tower pipe assembly 12 is a refrigeration line 14 through which coolant is allowed to flow from a remote source, not shown, as is well known. Refrigeration line 14 terminates in a pair of barb nipples 15 for connection to a supply line from the remote coolant source, thus the coolant is always within a closed system recirculating to the remote source and through refrigeration line 14. Also, extending into tower pipe assembly 12 is a beverage supply conduit 16 which connects with a fruit nipple 17 to a beverage source line from the remote beverage storage.

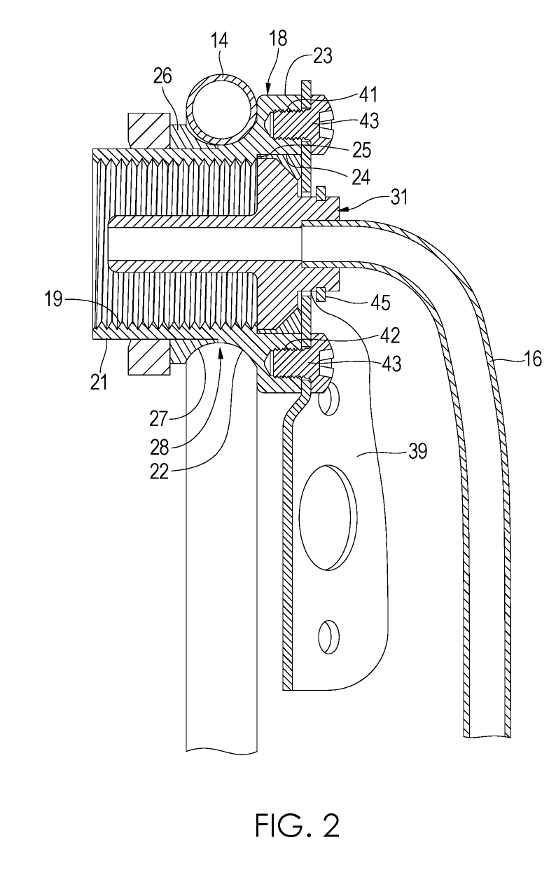

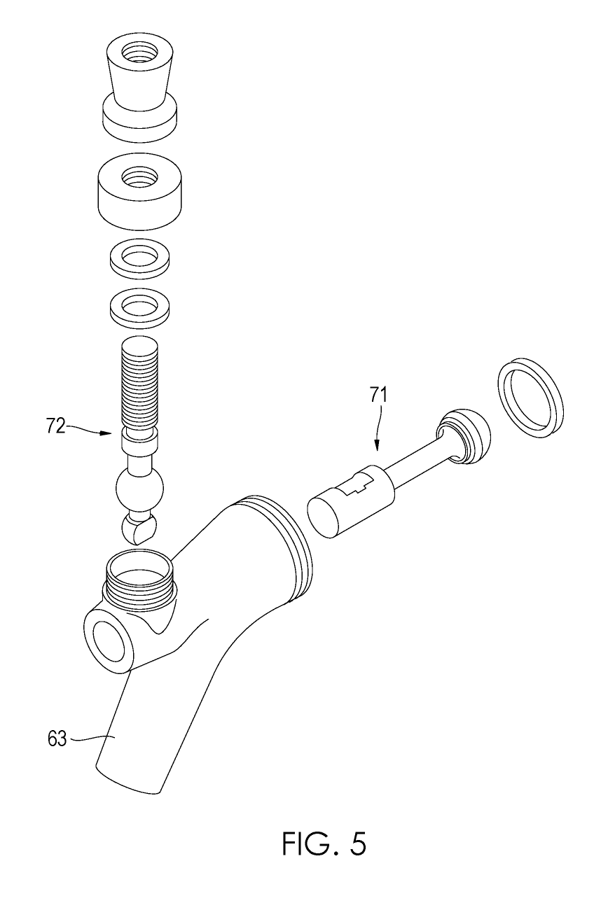

Referring to FIG. 2 and FIG. 5, we utilize a cold block 18 having a forward tubular portion 20 defining a forwardly opening internal threaded bore 19. A portion 21 of the exterior of cold block 18 surrounding the forward portion of the threaded bore 19 is reduced in diameter and terminates at a radiused portion 22 flaring outwardly to form a arcuate face on a base 23 of the cold block 18. Base 23 circumscribes a smooth bore 24 opening rearwardly of base 23 and in communication with threaded bore 19 at a shoulder 25 internally of cold block 18. Shoulder 25 extends radially and annularly of threaded bore 19 to define the larger diameter of smooth bore 24. As may be seen in FIG. 2 a cold block ring 26 slides onto reduced diameter portion 21 to abut radiused portion 22. Cold block ring 26 has a rear face 27 which is radiused to form a complimentary arcuate face which cooperates with radiused portion 22 to form a circumferential groove 28 about cold block 18 into which refrigeration line 14 is routed to the fullest extent possible to provide maximum thermal contact between refrigeration line 14 and cold block 18 such that cold block 18 is maintained at a cooled temperature. It will be understood that the present invention can be used in a multi-tap configuration such that a single refrigeration line serves to chill several cold blocks. In such a situation, the circumferential groove allows the refrigeration line to extend linearly along the multi-tap configuration routed in the circumferential groove of each cold block to provide contact at two points, that is at the top and bottom of each cold block, at a portion thereof closes to the tap. Thus, the beverage being delivered undergoes the maximum chilling just before it is dispensed from the selected tap.

Referring again to FIG. 2 and to FIG. 5, we provide a welding nipple 31 that serves as the delivery terminus for beverage supply conduit 16. Welding nipple 31 includes a rear annulus 32 surrounding a smooth rearwardly facing bore 33 into which beverage supply conduit 16 is received and joined to the welding nipple 31 by welding. Welding nipple 31 further includes a collar 34 extending radially outwardly of annulus 32. Forwardly of collar 34 welding nipple 31 forms an integral connection nipple 36 having a smooth outer surface 37 and a reduced diameter bore 38. Rearwardly facing bore 33 terminates at nipple shoulder 35 internally of welding nipple 31 near the rear side of collar 34 and communicates with reduced diameter forward bore 38. Thus, beverage supply conduit 16 is in fluid communication with reduced diameter bore 38. Collar 34 of welding nipple 31 fits snugly within smooth bore 24 of cold block 18 and abuts shoulder 25, thus providing thermal communication between cold block 18 and welding nipple 31 such that welding nipple 31 is maintained at a cooled temperature. Referring again to FIG. 2, note that welding nipple 31 is held in place in smooth bore 24 by a cold block patti 39 which is a stamped metal plate formed to receive rear annulus 32 there through and provided with apertures 41 and 42 through which threaded fasteners 43 attach cold block patti 39 to the rear of cold block base 23. A snap ring 45 seats within a locking groove 46 circumscribing rear annulus 32 to insure a secure connection of the welding nipple 31, patti 39 and cold block 18.

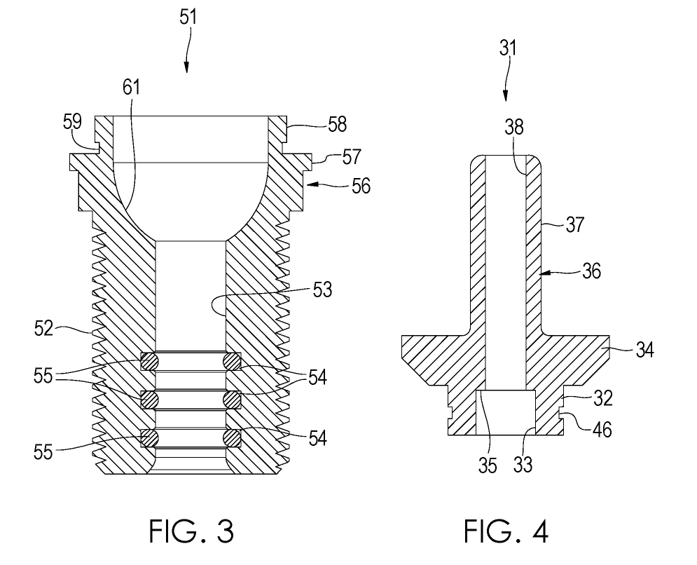

Referring to FIG. 1, it will be understood that the foregoing assembled components will fit within tower pipe assembly 12 with the threaded bore 19 aligned with a port 40 formed in the tower pipe assembly. Referring to FIGS. 1 and 3, it can be seen that glycol shank 51 includes a threaded outer surface 52 that engages the threaded inner 19 of cold block 18 by passing through port 40. Glycol shank 51 also includes a delivery bore 53 coaxial to threaded outer surface 52. Delivery bore 53 also includes a plurality of annular recesses 54 sized to receive and retain a plurality of O-ring seals 55 which engage and seal against the smooth outer surface 37 of connection nipple 36 when the glycol shank 51 is fully threadedly engaged with the cold block 18. Threaded outer surface 52 terminates near an annular collar 56 that includes an outwardly extending annular retaining flange 57 at its forward edge. The forward portion of glycol shank 51 beyond the flange 57 terminates in a splined rim 58 separated from the collar 56 by an annular recess 59. Within the forward portion of glycol shank 51 a frusto-spherical bore 61 communicates with delivery bore 53.

As may be seen in FIG. 1 conventional beverage dispensing spout 63 is provided to seat on the splined rim 58 and secured thereto by coupling nut 64 which includes an inner threaded bore for threaded engagement on the outer threaded surface of spout 63. An inwardly extending rear flange 66 engages outwardly extending annular retaining flange of glycol shank 51 to connect the spout in a known manner. A tubular tower flange 68 cosmetically mates the tower assembly to coupling nut 64. Referring to FIG. 6 and FIG. 3 it will be understood that faucet shaft assembly 71 is moved linearly by the action of tap lever 72 to seat in the frusto-spherical bore 61 in sealing relation or to an unseated position allowing beverage to flow through spout 63 as is well known.

It will be appreciated that certain key relationships make this design far simpler to maintain and service that the prior art. Importantly, the O-rings 55 are carried within the removable glycol shank 51. Thus, a technician servicing the dispensing tap can restore the unit to its original specifications by simply replacing the original glycol shank with a new shank having unworn O-ring seals. The original glycol shank can be readily refurbished at the technician's leisure by replacing the seals or the shank can be returned to a service center for refurbishing and reuse. Accordingly, the time the technician spends trying to remove and replace the sealing rings from a stationary dispensing tap is eliminated along with the protracted labor expense associated with the task. Likewise, the cold block is readily removed and replaced if necessary because welding nipple 31 is not permanently affixed thereto. Accordingly, cold block 18 may be detached from the welding nipple for any purpose which may arise including cleaning and the like by simply releasing the patti 39 and removing cold block ring 26 to disengage from the refrigeration line 14.

It is to be understood that the form of the invention shown is a preferred embodiment thereof and that various changes and modifications may be made therein without departing from the spirit of the invention or scope as defined in the following claims.

What is claimed is:

1. An apparatus for cooling a beverage dispensed there through comprising:
a. a cold block, for mounting in a beverage dispensing tower, comprising a forward tubular portion having an internally threaded bore there through, and a base integrally formed with said tubular portion and extending transversely thereof, said base having rearwardly opening bore having a diameter greater than said internally threaded bore;
b. a welding nipple including a collar extending radially outwardly from an integral connection nipple having a smooth outer surface and a internal bore, said collar dimensioned to be received within said rearwardly opening bore with said integral connection nipple extending within said internally threaded bore; and,
c. a glycol shank including an outer surface including a threaded outer portion for threaded engagement with said internally threaded bore, said shank defining a coaxial bore having a plurality of sealing members mounted there in for sealingly engaging said smooth outer surface of said connection nipple.

2. An apparatus as described in claim 1 wherein said welding nipple further defines a rearwardly opening enlarged diameter bore in fluid communication with said internal bore within said connection nipple and forming a shoulder within said welding nipple, said enlarged diameter bore adapted to receive a beverage supply conduit therein.

3. Apparatus as defined in claim 2 wherein said cold block includes a first arcuate face partially circumscribing said threaded bore and intermediate said tubular portion and said base, and further comprising a cold block ring slidably mounted on said tubular portion, said cold block ring defining a complementary arcuate face adjacent said first arcuate face and combining therewith to form an annular groove partially circumscribing said threaded bore and dimensioned to receive a refrigeration line therein.

4. Apparatus as defined in claim 1 wherein said cold block includes a first arcuate face partially circumscribing said threaded bore and intermediate said tubular portion and said base, and further comprising a cold block ring slidably mounted on said tubular portion, said cold block ring defining a complementary arcuate face adjacent said first arcuate face and combining therewith to form an annular groove partially circumscribing said threaded bore and dimensioned to receive a refrigerant line therein.

5. Apparatus as defined in claim 1 wherein said glycol shank includes a retaining flange for connection to a beverage dispensing spout.

6. Apparatus for connecting a beverage supply conduit to a beverage dispensing spout on a beverage dispensing tower including a cold block in communication with a refrigerant line for cooling said cold block, comprising:
a. a metallic glycol shank having a tubular portion defining an internal bore, said internal bore having at least one outwardly extending annular recess for retaining at least one sealing member therein, said tubular portion including a threaded exterior surface for threaded engagement within said cold block placing said glycol shank in thermal communication with said cold block and an external flange for connecting said shank to said beverage dispensing spout; and,
b. a metallic welding nipple including a connection nipple having a smooth outer surface and an internal bore said welding nipple having a collar received in said cold block such that said smooth outer surface of said connection nipple is in annular sealing connection with said at least one sealing member and said welding nipple is in thermal contact with said cold block, said welding nipple having a recess for receiving said beverage supply conduit externally of said cold block.

7. Apparatus as defined in claim 6 wherein said cold block includes a forward tubular portion having an internally threaded bore, and a base integrally formed with said tubular portion and extending transversely thereof, said base having rearwardly opening bore, having a diameter greater than said internally threaded bore, for receiving said metallic welding nipple therein.

8. Apparatus as defined in claim 7 wherein said welding nipple includes a collar extending radially outwardly from said connection nipple said collar dimensioned to be received within said rearwardly opening bore with said connection nipple extending within said internally threaded bore.
